(19) United States
(12) Patent Application Publication
(10) Pub. No.: US 2026/0221403 A1
(43) Pub. Date: Jul. 30, 2026

(54) MAGNETIC ASSEMBLY FOR A SPUTTER ION PUMP

(71) Applicant: Edwards Vacuum LLC, Sanborn, NY (US)

(72) Inventor: Derek Alexander Clement, Shakopee, MN (US)

(21) Appl. No.: 19/157,912

(22) PCT Filed: Sep. 6, 2023
(86) PCT No.: PCT/IB2023/058812

§ 371 Date: Aug. 19, 2025

(30) Foreign Application Priority Data
Feb. 22, 2023 (GB) 2302523.2

(51) Int. Cl. H01J 41/12

(52) U.S. Cl. CPC H01J 41/12

(57) ABSTRACT

Magnetic assembly for a sputter ion pump, SIP, comprising a pole piece, at least one magnet connected to the pole piece by a magnetic force of the at least one magnet, at least one cathode element connected to the at least one magnet and at least one bracket element connected to the at least one magnet by the magnetic force of the at least one magnet, wherein the at least one bracket element fixes the position of the at least one cathode element.

### CROSS-REFERENCE TO RELATED APPLICATION

This application is a Section 371 National Stage Application of International Application No. PCT/IB2023/058812 filed Sep. 6, 2023, and published as WO 2024/175980 A1 on Aug. 29, 2024, the content of which is hereby incorporated by reference in its entirety and which claims priority of British Application No. 2302523.2, filed Feb. 22, 2023.

### BACKGROUND

The present invention relates to a magnetic assembly for a sputter ion pump (SIP) and a vacuum pump comprising a sputter ion pump module with such a magnetic assembly.

Commonly known SIPs comprise one or more anodes built as tubes or cylindric openings wherein a magnetic field is oriented parallel to the central axis of the tubes. The anode is surrounded by cathode elements. In particular a cathode element is arranged opposite to the cylindric openings of the anode at a certain distance along the central axis. A strong electrical field is generated between the anode and the cathode. Due to the magnetic field, the path of the electrons within the anode cells are augmented which results in ionization of gas atoms and molecules in the vacuum chamber. The resulting ions are accelerated to strike the cathode element. On impact of the accelerated ions on the cathode elements, they will either become buried within the cathode material or sputter cathode material onto the other surfaces of the pump. The continuously sputtered chemical active cathode material acts as a getter which then evacuates the gas by both chemisorption and physisorption resulting in a net pumping action.

In common vacuum pumps cathode plates in the SIPs are typically held in place within the pump by means of welding or use of fasteners. This requires additional steps during assembly or additional parts in the vacuum. In particular if the cathodes are welded, replacement of the elements is not possible.

The discussion above is merely provided for general background information and is not intended to be used as an aid in determining the scope of the claimed subject matter. The claimed subject matter is not limited to implementations that solve any or all disadvantages noted in the background.

### SUMMARY

It is an object of the present invention to provide a magnetic assembly for a sputter ion pump with a simplified design to be placed in the vacuum.

The problem is solved by the magnetic assembly according to claim 1 and the vacuum pump according to claim 12.

The magnetic assembly for a sputter ion pump (SIP) according to the present invention comprises a pole piece and a least one magnet connected to the pole piece by a magnetic force of the at least one magnet. Further, at least one cathode element is connected to the at least one magnet. Therein, the cathode element can be directly connected and in direct contact with the at least one magnet or can be connected to the at least one magnet indirectly, i.e. due to the presence of intermediate elements between the cathode elements and the at least one magnet. Further, the magnetic assembly according to the present invention comprises at least one bracket element connected to the at least one magnet by the magnetic force of the at least one magnet, wherein the at least one bracket element fixes the position of the at least one cathode element. Hence according to the present invention, the at least one magnet is fixed in its position to the pole piece by its magnetic force. Preferably, the pole piece is made from a magnetic material such that there is an attracting force between the at least one magnet and the pole piece. Due to connection of the at least one magnet to the pole piece by the already present magnetic force of the at least one magnet, further fasteners or other fixing means can be avoided. Thus, the at least one magnet has two functions, first, providing the magnetic field for the SIP and second, fixing the position of the at least one magnet itself relative to the pole piece. In addition, also the at least one cathode element is connected to the at least one magnet by the magnetic force of the at least one magnet. Thus, also for fixing the position of the at least one cathode element, no further fastener or fixing means are necessary and additional parts within the vacuum can be avoided. Therefore, the bracket element is implemented to clamp or hold the at least one cathode element in the position, wherein the bracket element is connected to the at least one magnet due to the attractive magnetic force between the bracket element and the at least one magnet. Thereby assembly of the SIP is facilitated and the magnetic assembly can be completely placed in the vacuum.

Preferably, the at least one bracket element is made from a magnetic material. Thus, there is an attracting force between the at least one bracket element and the at least one magnet holding the bracket element and consequently also the cathode element in their position.

Preferably, the magnetic assembly comprises more than one magnet.

Preferably, the one or more magnets are neodymium magnets or samarium cobalt magnets.

Preferably, when the magnetic assembly comprises two or more magnets, than at least two magnets are separated by a separation element placed in between two respective magnets. The separation element may be built from a magnetic material. Preferably, the separation element is integrally formed with the pole piece. Thus, by the separation element, the two magnets can be placed in closed proximity, wherein by the separation element magnetic repulsion between equally magnetically oriented magnets can be eliminated.

Preferably, the pole piece and bracket element are nickel-plated in order to reduce outgassing within the vacuum environment.

Preferably, the cathode element is made from titanium or tantalum or a combination thereof. Thus, the cathode element is not attracted by the magnetic force of the at least one magnet and therefore fixing of the cathode element in the magnetic assembly is provided by the at least one bracket element.

Preferably, the cathode element is plate-shaped in order to provide a large surface for the pumping action of the SIP.

Preferably, the cathode element is provided by one piece. Thereby the number of elements within the vacuum can be further reduced thereby further simplifying the assembly of the SIP.

Preferably, the pole piece has a cylindric or semi-cylindric or part-cylindric shape, i.e. a circular cross-section, a semi-circular cross-section or a part-circular cross-section, respectively. For the case of a semi-cylindric shape of the pole piece in the SIP vacuum pump, two magnetic assemblies could be combined in order to provide a cylindric SIP module as described in more detail below.

Preferably, the pole piece has a recession wherein the at least one magnet is arranged in the recession. Therein, preferably the recession has a size equal to the total size of the one or more magnets. If there is one magnet, then the recession has a dimension corresponding to the dimension of the magnet to prevent movement of the magnet. If there are two or more magnets, then the recession has a size corresponding to the total dimension of the combined two or more magnets. Thus, by the recession the position of the magnet is fixed. Due to the magnetic force of the one or more magnets, the magnet is attached in the recession, wherein the sidewalls of the recession limit movement of the magnets.

Preferably, the at least one bracket element coverts at least partially a surface of the at least one cathode element facing away from the at least one magnet. In other words, the at least one bracket element embraces at least partially the at least one cathode element including a surface facing away from the at least one magnet. Thereby a clamping force can be generated by clamping the at least one cathode element in the direction of the magnet.

Preferably, the magnet has a first surface in contact or facing towards the cathode element and side surfaces perpendicular to the first surface. Preferably the at least one magnet has a second surface opposite to the first surface in contact with the pole piece.

Preferably, the complete first surface of the at least one magnet is in direct contact with the cathode element.

Preferably, the complete second surface of the at least one magnet is in direct contact with the pole piece and connected to the pole piece by the magnetic attraction of the at least one magnet.

Preferably, the at least one bracket element is connected to one of the side surfaces and in particular bracket element is connected to each of two opposing side surfaces. Thus, the bracket element is arranged at a side surface of the at least one magnet or the magnetic assembly comprises two bracket elements connected to two opposing side surfaces of the at least one magnet. If there are two or more magnets present, then two bracket elements may be connected to opposing side surfaces of the outermost magnets, i.e. the opposing side surfaces of the outermost magnets.

Preferably, the at least one bracket element protrudes over the first surface of the magnet in the direction of the cathode element in particular by a length corresponding to the thickness of the at least one cathode element. In particular, if the at least one bracket element embraces at least partially the at least one cathode element, the at least one bracket element protrudes over the first surface of the magnet to reach the surface of the at least one cathode element facing away from the magnet.

Preferably, the cathode element has a chamfered edge, wherein the chamfer of the chamfered edge faces away from the at least one magnet. Further, the bracket element comprises a corresponding chamfer facing towards the magnets, wherein the chamfered edge of the cathode element is in direct contact with the chamfer of the bracket element to apply a clamping force towards the magnet to the at least one cathode element.

Preferably, the chamfered edge of the cathode element has an angle of 45° or below, more preferably an angle of below 45° and most preferably an angle of 30° or below. By reducing the angle of the chamfered edge area of contact between the chamfered edge of the cathode element and the chamfer of the bracket element is increased, increasing the holding force, i.e. the force component in the direction of the magnet to clamp the cathode element.

Preferably, the bracket element is flush with the surface of the cathode element. In particular the bracket element is flush with the surface of the cathode element facing away from the magnet. Thus, the bracket elements can be built compact, and the cathode elements can be placed in close proximity to an anode of the SIP.

Preferably, according to the present invention no further fixing elements or fastening means are present for holding the at least one cathode element and/or the at least one magnet in their position. In particular the magnets as well as the cathode elements via the bracket elements are hold in place by the magnetic force of the at least one magnet alone.

In another aspect of the present invention a vacuum pump is provided comprising a sputter ion pump (SIP) module comprising an anode and at least one magnetic assembly as described before.

Preferably, the SIP module comprises two or more magnet assemblies wherein the two or more magnet assemblies combine to a cylindric shape of the SIP module.

Preferably, the vacuum pump further comprises a non-evaporable getter (NEG) module preferably connected to the top element of the SIP module, i.e. the upper side of the SIP module in a stacked manner. In particular the NEG module might be directly connected to the top element of the SIP module. Alternatively, the NEG module might be connected to the top element of the SIP module via an intermediate element in order to facilitate connection between the NEG module and the SIP module

Preferably, an outer structure of the SIP module and/or an outer structure of the NEG module are cylindrical. Therein for the SIP module the outer structure might be provided by the shell having a cylindrical shape. The outer structure may be a housing which may or may not vacuum tight. The housing may render the SIP module and/or the NEG module fully functional and preferably provides means for connecting the vacuum pump to a vacuum apparatus or chamber. Alternatively, the outer structure is surrounding the elements of the SIP module and/or the NEG module and built to be inserted in a vacuum apparatus or chamber. Therein, the outer structure may comprise openings to allow gas to enter into the SIP module or NEG module.

Preferably, the outer surface of the SIP module and the outer surface of the NEG module, in particular of the respective outer structures, flushes with each other providing an overall cylindrical shape of the vacuum pump.

Preferably, the vacuum pump comprises a flange wherein the SIP module is connected with its first end to the flange and preferably with its second end to the NEG module. In particular the SIP module is directly connected by a base element to the flange and the NEG module is connected to the SIP module via a top element of the SIP module. Alternatively, the base element of the SIP module is provided by the flange to connect the SIP module/NEG module to a vacuum apparatus or vacuum chamber.

Preferably, the SIP module and the NEG module are arranged within an area of the flange. Thus, the SIP module and the NEG module can be together inserted into a vacuum chamber and fixed to the vacuum chamber by the flange.

Preferably, the NEG module and/or the SIP module are completely arranged within the vacuum. In particular, due to the small building size of the NEG module and the SIP module, both can be inserted into a vacuum chamber and connected to the vacuum chamber by a flange. Thus, no additional volume of vacuum space is added to the vacuum chamber the vacuum pump is installed on and at the same time due to the present invention the number of parts in the vacuum is reduced relative to if a standard ion pump design were modified in order to be mounted to a flange.

Preferably, the SIP module comprises an outer structure wherein the outer structure is built by the pole piece.

The summary is provided to introduce a selection of concepts in a simplified form that are further described in the detailed description. This summary is not intended to identify key features or essential features of the claimed subject matter, nor is it intended to be used as an aid in determining the scope of the claimed subject matter.

### BRIEF DESCRIPTION OF THE DRAWINGS

In the following the present invention is described in more detail with reference to the accompanying figures. The figures show:

FIG. 1 a vacuum pump according to the present invention,

FIG. 2 a sectional view of the vacuum pump of FIG. 1,

FIG. 3 a frame structure of the vacuum pump of FIG. 1,

FIGS. 4A and 4B the frame structure and an anode of the vacuum pump of FIG. 1,

FIGS. 5A-5C a shell element of the vacuum pump of FIG. 1,

FIGS. 6A and 6B a sectional view of a non-evaporable getter module,

FIG. 7 a connecting element according to the present invention,

FIGS. 8A and 8B insulation elements according to the present invention,

FIG. 9 a sectional view of the SIP module according to FIG. 1.

### DETAILED DESCRIPTION

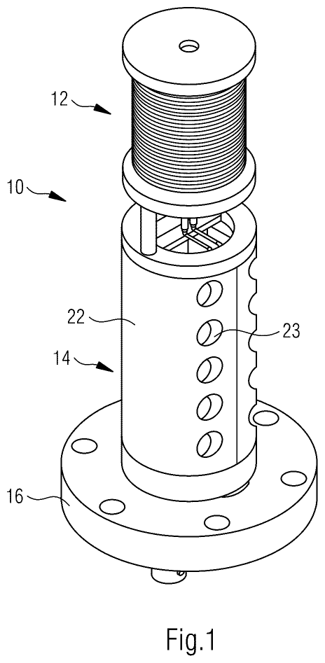

Referring to FIG. 1 showing a vacuum pump 10 according to the present invention. Therein the vacuum pump 10 comprises a non-evaporable getter (NEG) module 12, a sputter ion pump (SIP) module 14 and a vacuum flange 16. Therein the SIP module 14 is directly connected to the flange 16, wherein the NEG module 12 is attached to the SIP module 14 opposite to the flange 16. The vacuum pump 10 and in particular both the NEG module 12 and the SIP module 14 have a cylindric shape. The shape of the SIP module 14 flushes with the shape of the NEG module 12 such that the SIP module 14 and the NEG module 12 may have a substantially similar or identical outer shape or at last cross-section. Although in the following figures the vacuum pump has a cylindrical shape, other shapes are also possible.

The NEG module 12 and the SIP module 14 are arranged within the area of the flange 16 and can be completely inserted into a vacuum chamber for pumping.

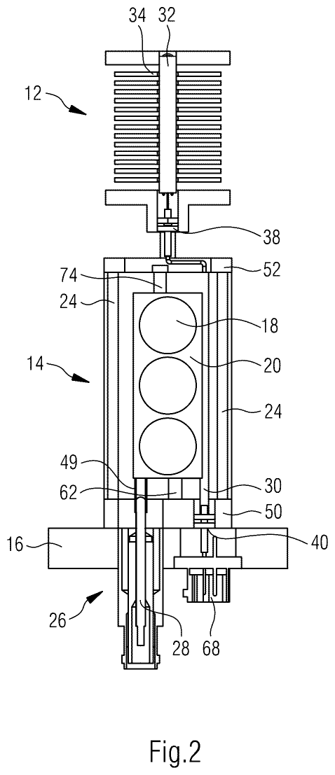

Referring to FIG. 2. In the section view it is shown that the SIP module 14 comprises an anode 20 which has in the example of FIG. 2 three cylindrically shaped openings or tubes. Other numbers of tubes are also possible. At an axial end of these openings a cathode 18 is disposed. The anode 20 is kept on a high electrical potential by a high voltage (HV) conductor 28 guided through the flange by a vacuum feedthrough 26 and connected to the anode. Furthermore, the flange 16 comprises a connector 68 which is connected via an electrical lead 30 with a heating element 32 of the NEG module 12. NEG elements 34 are arranged onto the heating element 32 for re-activation of the NEG material by heating up.

Here and in the following the axial direction of the SIP and its element is defined along the anode from its lower side to its upper side. Here and in the following, the lateral direction refers to a direction perpendicular to the axial direction of the anode.

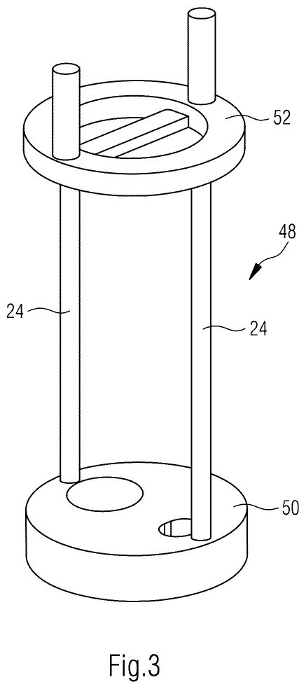

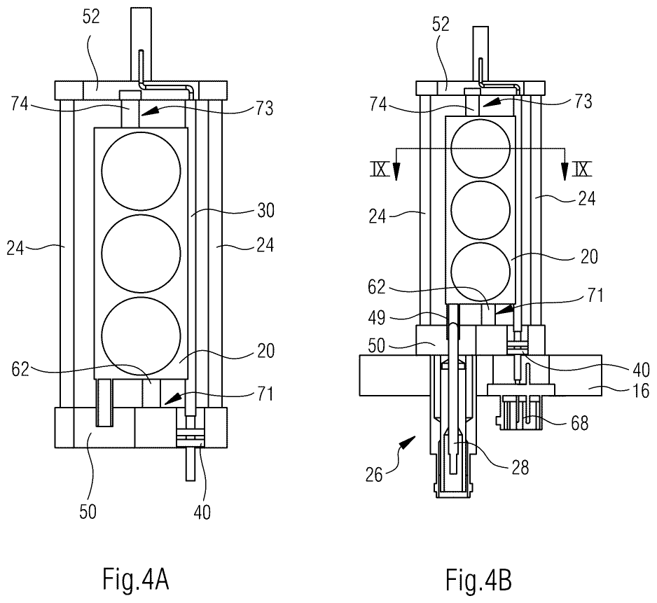

Referring to FIG. 3 showing the frame structure 48 of the SIP module. The frame structure 48 comprises a base element 50 which can be attached to the flange 16 by welding, brazing, soldering, screws or any other releasable connection means. In other embodiments the flange 16 and the base 50 are integrally built or the base element 50 may be provided by the flange 16 itself. Connected to the base element 50 are in the example of FIG. 3 two frame side elements 24 built as shoulder screws or posts which extend from the base element 50 to a top element 52. The NEG module 12 can be connected to the top element 52 by welding, brazing, soldering, screws or any other releasable connection means. During assembly, the anode 20 is fixed within the frame structure 48 and subsequently the frame structure 48 together with the anode 20 is connected to the flange 16. This is shown in FIGS. 4A and 4B. The anode 20 is connected in the frame structure 48 by a lower support element 71 provided by an insulating element 62 connected to the anode 20. Further, an upper support element 73 is provided by an insulating element 74. Therein, the insulating elements 62, 74 are built by an insulating material such as a ceramic material. By the lower insulating support 71 the anode 20 is restricted from downward motion towards the flange 16 and might also be restricted by lateral motion, i.e. in one or more other directions or all other directions. By the upper support element 73, the anode 20 is restricted from upward motion and lateral motion, i.e. in one or more other directions or all other directions. The at least one support element 71, 73 or the two support elements 71, 73 may not fully restrict lateral movement allowing slight lateral movement of the anode while connecting the anode to the HV conductor 28 in order to facilitate mounting the HV conductor 28 to the anode 20. Thus, a secure connection between the HV conductor 28 and the anode 20 is possible and slight manufacturing deviations can be compensated for. In order to prevent motion of the anode 20 completely and fix the anode's position in the frame structure, the anode 20 is connected to the HV conductor 28, extending through an opening in the base element 50, via a conducting sleeve 49, connecting the anode 20 with the HV conductor 28 of the vacuum feedthrough 26. Thus, by the lower support element 71, the upper support element 73 and the connection to the HV conductor 28 of the electrical feedthrough 26, the anode 20 is fixed in its position within the frame structure 48 of the SIP module 14.

The steps for assembling the SIP module 14 thus comprise:
a) providing a frame structure preferably comprising base element 50, one or more frame side elements 24 connected to the base element, and may also include a top element 52 connected to the respective frame side elements 24
b) inserting the anode and connecting the anode in the frame structure by the lower support element 71 and the upper support element 73,
c) attaching the frame structure 48 together with the anode 20 to the flange 16, thereby connecting the anode 20 to the electrical feedthrough 26 and simultaneously fixing the position of the anode 20 in the SIP module 14,
d) attaching the shell around the frame structure 48 as explained in more detail below.

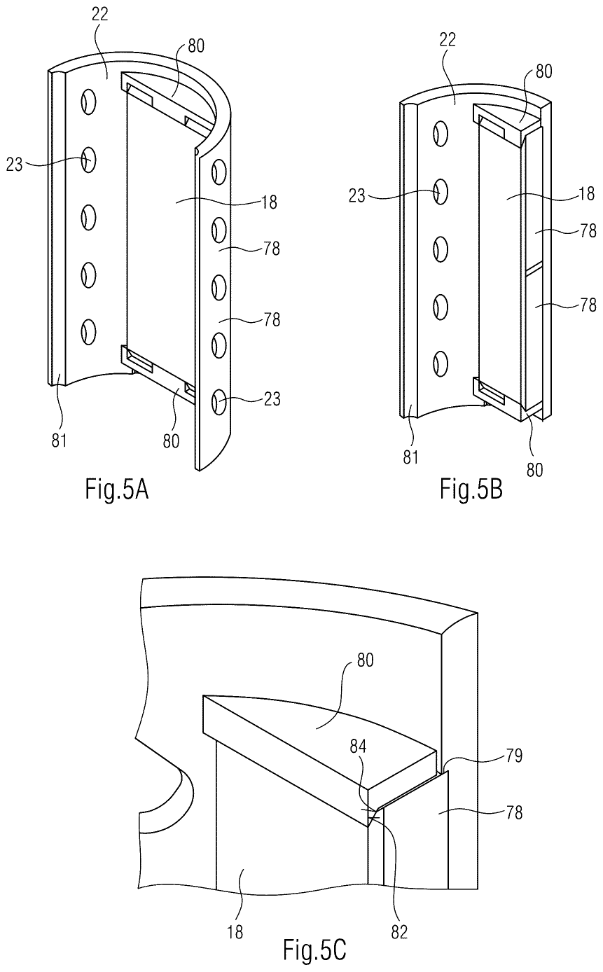

Referring to the FIGS. 5A-5C showing details of the shell of the vacuum pump 10. The shell of the vacuum pump 10 and in particular of the SIP module 14 comprises two individual shell elements 22. Therein, each shell element 22 is built identically in the present embodiment but the shell elements 22 may also be built/designed differently. Each shell element 22 comprises at least one magnet 78, wherein in the example of FIGS. 5A-5C each shell element 22 comprises two magnets 78. Therein, the magnets 78 are arranged in a recession 79 of the shell element 22 in order to prevent lateral movement. The size of the recession 79 is adapted to the size of the magnets such that sidewalls of the recession 79 directly contact sidewalls of the respective magnets 78. The magnets 78 are attached to the respective shell elements 22 only by their magnetic force. No further fixing/fastening elements are present. Thus, the shell elements 22 serve as both pole pieces and the outer structure for the SIP module 14. The pole pieces guide the magnetic flux through the SIP module 14, and the outer structure provides structural stability to the SIP module 14. Therefore, the shell elements 22 are made from a magnetic material such as mild steel. The magnets 78 are neodymium (Nd) magnets or samarium (Sa) cobalt (Co) magnets. The magnets are attached with one surface to the shell element 22. An opposite surface of the magnets 78 is directly connected to the cathode 18. The cathode 18 is plate-shaped and covers the complete or substantially complete surface of the magnets 78. The cathode 18 may be made from titanium (Ti) or tantalum (Ta). The two shell elements 22 may comprise cathode elements 18, 18′ made from the same material or different material. In order to fix the cathode 18 in its position, bracket or clamping elements 80 are provided at the upper end and lower end of the respective magnets 78. The bracket elements 80 are held in place by the magnetic force of the magnets 78. No additional fixing elements are necessary. The bracket elements 80 comprise a chamfered surface 84 with a chamfer towards the magnets 78. Similarly, the cathode element 18 comprises chamfered edges 82 with a chamfer facing away from the magnets 78 and corresponding to the chamfered surface 84 of the bracket elements 80. When attaching the bracket element 80 to the side of the magnets 78, a clamping force is applied to the cathode 18 to fix the position of the cathode 18. The surface of the cathode element 18 flushes with the respective bracket element 80 and thus close positioning of the cathode element 18 to the anode 20 is feasible. Further, assembly and disassembly of the cathode elements 18 can be done without the need of additional tools.

The two shell elements 22 resemble the outer shape of the SIP module 14. The shell elements 22 have openings 23 to allow gas molecules and particles to enter the active volume of the SIP module. The present invention is not limited by the number or shape of these openings 23. In order to have sufficient stability of the shell elements, the shell elements 22 provide at their axial edge an indentation 81 along an axial direction of the shell elements 22 which accommodates the frame side elements 24 when attached to them. Thus, by the corresponding shape of the indentations 81, the position of the elements 22 are defined by the position of the frame side elements 24.

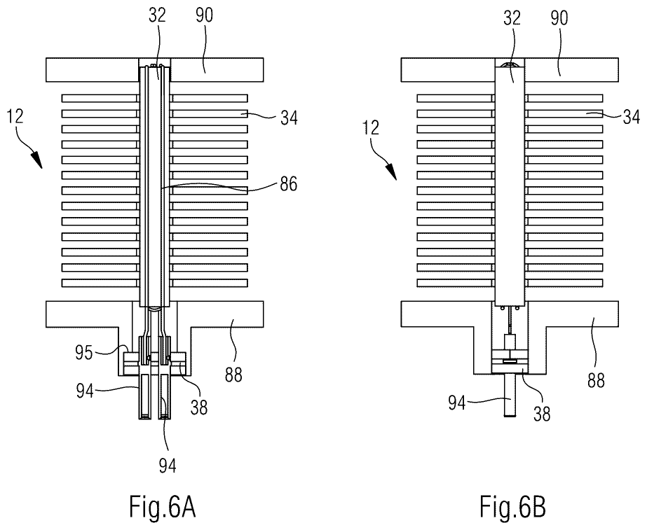

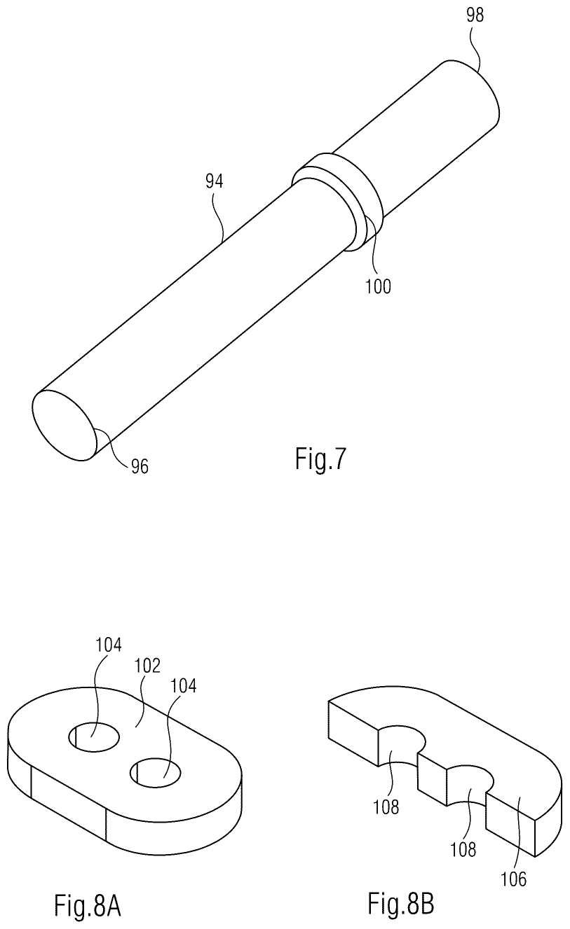

Referring to FIGS. 6A and 6B showing the NEG module 12 comprising a heater 32 with heating wire 86. The NEG module 12 comprises a base element 88 and top element 90, wherein NEG elements 34 are sleeved over the heater 32. The top element 90 and the base element 88 might be connected by NEG side elements such as shoulder screws or posts. In particular the NEG side elements are built by threaded rods or posts. The electrical connection of the heater 32 is provided by an electrical connector 38 having connection elements 94. The connection elements 94 are shown in more detail in FIG. 7. The connection elements 94 comprise a first end 96 and second end 98. Between the first end 96 and the second end 98 a collar or protruding feature 100 is present. Although shown in FIG. 7 that the first end 96 and the second end 98 may have the same diameter, the present invention is not limited to this example and also different diameters of the first end 96 and the second end 98 would be possible. Similarly, the example of FIG. 7 shows a circular cross section wherein other shapes are of course also possible.

The connector 38 comprises insulating elements 102, 106 as shown in FIGS. 8A and 8B. A first insulating element 102 has openings 104. Therein the number of openings 104 corresponds to the number of connecting elements 94. The diameter of the openings 104 corresponds to the diameter of the first end 96 and preferably the insulating elements 102 is made from a ceramic material. Similarly, the second insulating element 106 is made from a ceramic material. The second insulating element 106 is built by two halves, wherein FIG. 8B shows only a single halve. By the two halves of the insulating element 106 openings 108 are established, wherein the diameter of the openings 108 correspond to the diameter of the second end 98 of the connecting element 94. The connecting element 94 is crimped or otherwise attached to the heating wire 86 of the heater 32. Subsequently the two halves of the second insulating element are inserted into a housing of the base element 88 of the NEG module 12 and sits on a shoulder 95. Therein, due to the protruding feature 100, the connecting elements 94 cannot fall through the openings 108 of the second insulating element 106. Subsequently, the first insulating element 102 is assembled by inserting the first end 96 of the connecting elements 94 into the respective openings 104. Due to the protruding feature 100, the connecting elements 94 cannot fall out of the first insulating element 102. By a fixing element, for example provided by a set screw, the first insulating element 102 and the second insulating element 106 are fixed in their position. Thereby, no clamping force is directly acting on the connecting elements 94. Due to the protruding feature 100, the fixing element 94 is fixed in its axial position wherein a slight lateral movement of the connecting element 94 is still allowed and helps during assembly of the NEG module 12.

Similar to the connector 38 connecting the NEG module 12 to the SIP module 14, a connector 40 is provided in order to connect the SIP module to the flange 16 as shown in FIGS. 4A and 4B. Thereby, an electrical lead 30 to be connected to the heater 32 runs from the flange 16 through the complete SIP module 14 and via the connector 38 to the NEG module 12. The electric lead 30 may comprise two electrical wires 110, 110′ which are surrounded by an insulating material such as a ceramic material.

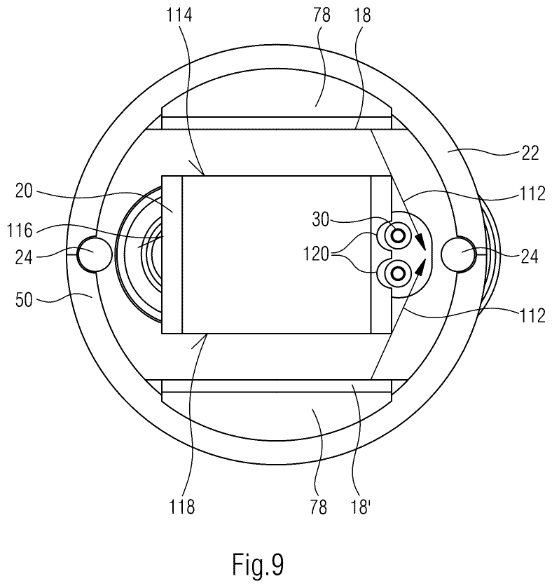

In the following it is referred to FIG. 9 showing a sectional top view of the SIP module 14. The anode 20 has a first surface 114 and an opposite second surface 118, which correspond to the axial direction of the cylindric openings in the anode 20. The first surface 114 and the second surface 118 are connected by side surfaces 116, wherein the electrical lead 30 runs along a side surface 116 of the anode 20. Due to the position of the electrical lead 30, there is no direct line or line of sight 112 between the cathode element 18 and the electrical lead 30 preventing or at least reducing the likelihood of sputtering material of the cathode 18 onto the surface of the electrical lead 30 which may produce shorts. Thus, the electric lead 30 is protected by the anode 20 itself. Therefore, the side surface 116 of the anode may comprise indentations 120 which accommodate the electrical lead 30 and the respective wires 110, 110′ of the electrical lead 30. Thus, the low voltage supply of the heater 32 of the NEG module 12 is running from the connector 68 via the connecting element 40 and the electrical lead 30 across the SIP module 14 and in particular within the pole pieces of the SIP module provided by the shell elements 22 towards the connector 38 at the top element 52 of the SIP module and then further to the connector 38 and the heater 32.

Thus, by the vacuum pump according to the present invention a combination of an NEG module and an SIP module is provided which can both be completely inserted into the vacuum chamber having a small cross-sectional area. At the same time, due to implementing a frame structure 48 and a shell, the process of assembling the SIP module 14 is simplified and the number of necessary parts in the vacuum can be reduced.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A magnetic assembly for a sputter ion pump, SIP, comprising:
a pole piece,
at least one magnet connected to the pole piece by a magnetic force of the at least one magnet,
at least one cathode element connected to the at least one magnet and
at least one bracket element connected to the at least one magnet by the magnetic force of the at least one magnet, wherein the at least one bracket element fixes the position of the at least one cathode element.

2. The magnetic assembly according to claim 1, wherein the pole piece has a cylindric or semi-cylindric or part-cylindric shape.

3. The magnetic assembly according to claim 1, wherein the pole piece has a recession, wherein the at least one magnet is arranged in the recession.

4. The magnetic assembly according to claim 3, wherein the recession has a size equal to the total size of the one or more magnets.

5. The magnetic assembly according to claim 1, wherein the at least one bracket element covers at least partially a surface of the at least one cathode element facing away from the at least one magnet.

6. The magnetic assembly according to claim 1, wherein the at least one magnet has a first surface in contact or facing towards the cathode element and side surfaces.

7. The magnetic assembly according to claim 6, wherein the at least one bracket element is connected to one of the side surfaces and wherein in particular to two opposing the side surfaces of the at least one magnet a bracket element is connected.

8. The magnetic assembly according to claim 6, wherein the at least one bracket element protrudes over the first surface of the magnet, in particular by a length corresponding to the thickness of the at least one cathode element.

9. The magnetic assembly according to claim 1, wherein the at least one cathode element comprises a chamfered edge, wherein the chamfer faces away from the magnet, wherein the bracket element comprises a corresponding chamfer facing towards the magnet, wherein the chamfered edge of the cathode element is in direct contact with the chamfer of the bracket element to apply a clamping force to the at least one cathode element.

10. The magnetic assembly according to claim 1, wherein the bracket element is flush with the surface of the cathode element.

11. The magnetic assembly according to claim 1, wherein no further fixing elements are present for holding the at least one cathode element and/or the at least one magnet in position.

12. A vacuum pump comprising a sputter ion pump, SIP, module, comprising an anode and at least one magnetic assembly according to claim 1.

13. The vacuum pump according to claim 12, wherein the SIP module comprises two or more magnet assemblies, wherein by the two or more magnet assemblies a cylindric shape of the SIP module is provided.

14. The vacuum pump according to claim 12, wherein the magnetic assembly is located in the vacuum.
